(19) United States
(12) Patent Application Publication
(10) Pub. No.: US 2007/0042164 A1
(43) Pub. Date: Feb. 22, 2007

(54) Translucen decorative image element and process for producing the same

(76) Inventor: Susanne Hader, Gummenen-Mauss (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/563,789

(22) PCT Filed: Jul. 7, 2003
(86) PCT No.: PCT/IB03/02682

§ 371 Date: May 2, 2006

(51) Int. Cl. B32B 3/00

(52) U.S. Cl. 428/203; 428/34.1

(57) ABSTRACT

A decorative element comprises a translucent substrate and an image pattern applied thereto. The substrate comprises at least one support surface covered by a translucent adhesive layer and an image layer that contains an image pattern on the side of the adhesive layer away from the substrate. The image layer, including its edges, is entirely covered by a translucent covering layer.

### FIELD OF THE INVENTION

The present invention relates to a decorative element according to the preamble of claim 1 and to a process for producing the same.

### DISCUSSION OF BACKGROUND ART

U.S. Pat. No. 2,593,936 describes a process for fixing on a glass surface a gelatine layer that is provided with a photographically or typographically produced image pattern. In particular, a goal of the known process is to provide a glass tabletop with a decorative image pattern, wherein the latter shall be fixed so that it will not readily be scratched or damaged by humidity. For this purpose, the glass surface to be coated with the image pattern is initially provided with a plurality of small recesses; this can be achieved, for example, by covering the surface with a grid-shaped mask and etching with hydrofluoric acid. The gelatine layer having the image pattern is soaked in a heated liquid resin adhesive and then laid on the preconditioned glass surface and pressed against it. Finally, the whole assembly is heated in order to harden the resin adhesive. In order to achieve a pleasing result, the dimensions of the recesses formed into the glass surface are chosen so that upon looking at the image pattern through the glass no noticeable image deformation is evident. Nevertheless, the glass surface cannot be made as smooth as would be desirable for aesthetic reasons.

A significant disadvantage of the known process is that the required preconditioning of the glass surface is laborious and therefore also expensive. The use of hydrofluoric acid requires particular safety measures, corresponding safety equipment and specifically trained personnel. A further disadvantage arises from the fact that the soaking of the gelatine film with resin adhesive does not always leads to a uniform coverage. For this reason, the mechanical stability of the product made by this process is not perfect; in particular, there is the danger that in the cured resin adhesive cracks are formed or that fragments of the gelatine film that were insufficiently covered with resin are damaged by external mechanical influences. Finally, the heat treatment that is required in the known process can also be disadvantageous, because not all materials that are suitable as support for an image pattern are also heat-resistant.

### SUMMARY OF THE INVENTION

The object of the invention is to provide a decorative element and a process for producing the same that allow overcoming the above-mentioned disadvantages.

These objects are achieved by means of the decorative element defined in claim 1 and by the process for producing the same defined in claim 9.

The decorative element of the present invention comprises a translucent substrate and an image pattern applied thereto. The substrate comprises at least one support surface covered by an adhesive layer, with an image layer comprising the image pattern being arranged on the side of the adhesive layer away from the substrate and with the entire image layer including its edges being covered with a translucent covering layer.

In the process according to the present invention one initially covers the support surface of the substrate with an adhesive layer whose dimensions are adapted to the image pattern to be applied. Subsequently, one applies the image layer containing the image pattern on the side of the adhesive layer away from the substrate, and finally one applies a translucent covering layer on the image layer in such a way that the entire image layer including its edges is covered.

Accordingly, it is not necessary to form recesses into the support surface intended to bear the image pattern. Accordingly, the support surface can be formed very smoothly and an aesthetically pleasing result can be achieved. Moreover, due to the comparatively simple manufacturing process, which particularly does not require a specific mechanical treatment of the support surface or the use of hydrofluoric acid and the associated safety measures, results in a considerable reduction of production costs and a lower environmental burden. By virtue of the fact that the entire image layer including its edges is covered by the covering layer, an air- and water-proof closure is obtained which to a large extent protects the image layer from external exposure and thus ensures a durable appearance of the decorative element.

Advantageous embodiments of the present invention are defined in the dependent claims.

In principle, various translucent materials can be used for the substrate, including, in particular, polymethacrylate (Plexiglas®). Preferably, according to claim 2, the translucent substrate is made of glass, which has the advantage of a high temperature resistance, a good shape consistency and a high transparency. Moreover, a glass substrate can be provided with a support surface of excellent planarity. A further advantage of a glass substrate is given by the fact that all of the external surfaces, i.e. not just the support surface itself, can be very smooth, which yields a visually pleasing result.

In principle, various types of translucent adhesive layers can be used. For example, the adhesive layer can be sprayed onto the support surface. Preferably, according to claim 3, the adhesive layer is made of a bilaterally adhesive transparent foil, which provides for a good fixation of the image layer onto the substrate and nevertheless has a good light transmittance.

The image layer containing the image pattern can be applied onto the adhesive layer by an inkjet process, for example. Preferably, according to claim 4, the image layer is made of a foil containing the image pattern, in particular a clear film foil. This results in a good optical fidelity for details and a brilliant color authenticity.

Claim 5 relates to a particularly preferred embodiment, according to which the translucent covering layer is made of a clear lacquer. Preferably, this is a sprayable clear lacquer that forms a highly transparent, mechanically resistant covering layer upon hardening. Particularly suitable are lacquers that are intended for making cover layers of automobiles.

Various shapes of translucent substrates may be used, which, for example, may be designed as a translucent full body. According to claim 6, plate-shaped substrates that are suitable, in particular, for tables and other furniture pieces, for mural pictures, but also for more complex composite objects may be used for many applications. According to claim 7, substrates that are designed as hollow bodies are suitable, for example, as illumination devices.

In the embodiment according to claim 8, the decorative element further comprises a UV protection layer for the image pattern. In particular, this should avoid a bleaching of the image pattern under the influence of sunlight. Optionally, the UV protection layer can be applied as an external layer on the decorative element, so that in addition to the image pattern the covering layer is also protected from the influence of the sun.

In principle, the transparent covering layer can be painted, spread or otherwise applied in form of a foil. Particularly preferred is the embodiment of claim 10, according to which the transparent covering layer is sprayed onto.

### BRIEF DESCRIPTION OF THE DRAWINGS

Exemplary embodiments of the invention are explained in detail hereinbelow with reference to the drawings, wherein:

FIG. 1 shows a decorative element, in top view;

FIG. 2 shows the decorative element of FIG. 1 according to section II-II of FIG. 1;

FIG. 3 shows a further decorative element, in a cross-sectional representation.

### DESCRIPTION OF THE PREFERRED EMBODIMENTS OF THE INVENTION

The exemplifications set out herein are not to be construed as limiting the scope of this invention in any manner. Depending on the circumstances, the skilled person will also take into consideration modified embodiments that rely on the same principles.

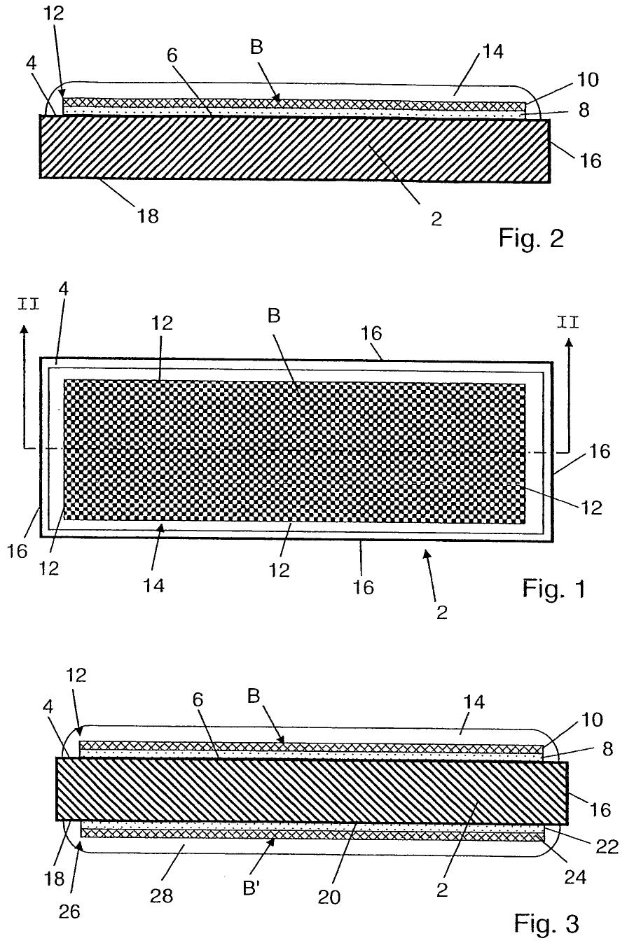

The decorative element shown in FIGS. 1 and 2 comprises a glass top 2 acting as translucent substrate, whose front surface 4 shown laying on top in FIG. 2 forms a substantially planar frontside support surface 6 for a frontside image pattern B. The support surface 6 is covered with a frontside translucent adhesive layer 8, on whose side away from the substrate there is arranged a frontside image layer 10 comprising the image pattern B. The entire image layer 10 including its frontside edges 12 is covered with a translucent frontside covering layer 14. In the example shown, the lateral surfaces 16 and the back surface 18 laying adjacent to the support surface 6 are not covered.

A further decorative element is shown in FIG. 3. This one also comprises a glass plate 2, but in contrast to the element of FIGS. 1 and 2 the front surface 4 and also the back surface 18 are both provided with an associated image pattern B and B′, respectively. The method for applying the backside image pattern B′ is identical to that for the frontside image pattern B: the back surface 18 forms a backside support surface 20 that is covered with a backside adhesive layer 22, on whose side away from the substrate there is arranged a backside image layer 24 comprising the image pattern B′. The entire backside image layer 24 including its backside edges 26 is covered with a translucent covering layer 14. In the embodiment here described the visual appearance of the decorative element is determined by both image patterns. In particular, due to light refraction at the various layer boundaries, there results an apparent lateral displacement between the two image patterns. This allows achieving quasi-three-dimensional image effects in accordance with the intended application of the decorative element.

The production of a plate-shaped decorative element is described hereinbelow, and the production of non-plate-shaped decorative elements is carried out in an analogous manner. A plate made of white glass (so called “opti-white”) with dimensions of 140×100×25 cm was covered on its frontside with a bilaterally adhesive transparent foil of the type Permatrans 2113, 36 Micron, manufactured by Mactac. The foil was previously cut to an area of 138×98 cm and was applied to the glass plate in such a way that a border of approximately 1 cm was left uncovered all around. Subsequently, an image foil comprising an image pattern in the form of a photographic clear film (“clear film”) with area dimensions 138×98 cm was congruently applied onto the adhesive layer. Finally, a clear lacquer of the type PPG 2. k. typically used as a lacquer for automobiles was applied by means of a spraying device as a uniformly covering layer with a thickness of 0.5 mm onto the image foil and onto a zone of the glass plate surrounding the image foil in a distance of approximately 1 mm. The decorative element thus produced was then stored at room temperature for 3 days in order to achieve a complete hardening of the clear lacquer. Optionally, then, in a second processing step a backside image pattern can be applied in the same way. In principle, it is also possible to provide both sides of the plate with image patterns in a single processing step, but in this case suitable attachment and manipulation equipment is required.

A plate-shaped decorative element of the above-mentioned type can be used, for example, as a tabletop. Further application possibilities comprise, for example, picture-like wall decorations, sections of a floor and room separation elements. For outdoor use, such as for facades of buildings, the elements should preferably be provided with a UV protection layer. Plate-shaped elements can also be used for constructing hollow bodies, which, in particular, are suitable for illumination elements with a light source arranged within the hollow body. Further applications comprise non-plate-shaped decorative elements, for example in the form of a massive cube or cuboid that are provided on one or several surfaces thereof with an image element.

Depending on the types of use, the surrounding, and the light situation, more or less strongly colored image patterns are advantageous for achieving aesthetically pleasing results.

By using original image patterns such as unique pieces or limited series, the decorative element can be provided with an added value.

### LIST OF REFERENCE NUMERALS

2 substrate
4 front surface of 2
6 frontside support surface
8 frontside adhesive layer
10 frontside image layer
12 frontside edges of 10
14 frontside covering layer
16 lateral surface of 2
18 back surface of 2
20 backside support surface
22 backside adhesive layer
24 backside image layer
26 backside edges of 24
28 backside covering layer
B, B′ image pattern

1.-10. (canceled)

11. Decorative element with a translucent substrate and an image pattern applied thereto, characterized in that the substrate comprises at least one support surface covered by a translucent adhesive layer, wherein the adhesive layer is made of a bilaterally adhesive transparent foil and wherein an image layer comprising the image pattern is arranged on the side of the adhesive layer away from the substrate, and wherein the entire image layer, including its edges, is covered with a translucent covering layer.

12. Decorative element according to claim 11, characterized in that the substrate is made of glass.

13. Decorative element according to claim 11, characterized in that the image layer is made of an image foil containing the image pattern.

14. Decorative element according to claim 11, characterized in that the translucent covering layer is made of a clear lacquer.

15. Decorative element according to claim 11, characterized in that the substrate is substantially plate-shaped.

16. Decorative element according claim 11, characterized in that the substrate is shaped as a hollow body.

17. Decorative element according to claim 11, characterized in that the decorative element it is provided with a UV protection layer for the image pattern.

18. Process for producing a decorative element according to claim 11, comprising covering the support surface of the substrate with a translucent adhesive layer, the dimensions of which are chosen in accordance with the image pattern to be applied, subsequently applying the image layer containing the image pattern on the side of the adhesive layer away from the substrate, and finally applying a translucent covering layer on the image layer in such a way that the entire image layer including its edges is covered.

19. Process according to claim 18, characterized in that the translucent covering layer is applied by spraying.

20. Decorative element according to claim 12, characterized in that the image layer is made of an image foil containing the image pattern.

21. Decorative element according to claim 13, characterized in that the translucent covering layer is made of a clear lacquer.

22. Decorative element according to claim 14, characterized in that the substrate is substantially plate-shaped.

23. Decorative element according claim 14, characterized in that the substrate is shaped as a hollow body.

24. Decorative element according to claim 16, characterized in that the decorative element it is provided with a UV protection layer for the image pattern.
